(19) United States
(12) Patent Application Publication
(10) Pub. No.: US 2020/0070071 A1
(43) Pub. Date: Mar. 5, 2020

(54) DEVICE FOR FILTERING

(71) Applicant: KIN MUN CHIN, SELANGOR (MY)

(72) Inventor: KIN MUN CHIN, SELANGOR (MY)

(21) Appl. No.: 16/451,729

(22) Filed: Jun. 25, 2019

(30) Foreign Application Priority Data
Sep. 5, 2018 (MY) PI2018703147

(51) Int. Cl. B01D 33/01; B01D 29/11; B01D 29/90

(52) U.S. Cl. CPC B01D 33/0183; B01D 2201/4092; B01D 29/90; B01D 29/114

(57) ABSTRACT

A device and method for filtering a liquid, wherein the device (100) comprises a container (110), a filter unit (120) and a filtering medium (130). The container (110) holds the liquid (10) containing a solid substance (10a), and the filter unit (120) is slidable in the container (110). The filtering medium (130) is non-permeable to the solid substance (10a) in the liquid (10).

### FIELD OF THE DISCLOSURE

The present disclosure relates to liquid filtration, in particular to a device and method for filtering a liquid and holding the filtrate separately.

### BACKGROUND

In the modern medical world, it has become an increasing importance to analyze a physiological fluid e.g. blood, urine and the like. For this purpose, it is necessary to separate or filter one or more solid substances from the fluid.

Two different conventional arrangements for filtering the liquid are shown in FIGS. 7A-7B. In FIG. 7A, a typical filtration approach is explained, wherein the liquid is held in an upper container (20) which has a filtering medium (40) and a plunger (50). The plunger (50) exerts a pressure on the liquid. As the filtering medium (40) is only permeable to a liquid (10), a solid substance (10a) contained in the liquid (10) is retained in the upper container (20), while the liquid (10) passes through the filtering medium (40) and gets collected in a lower container (30). However, there is a high chance for the solid substance (10a) to form a blocking layer on top of the filtering medium (40). Therefore, there is a need for the plunger (50) to exert an external pressure to force the liquid (10) to pass through the solid substance (10) and the filtering medium (40).

In FIG. 7B, a reverse-filtration approach is explained, wherein a lower container (30) holds the liquid, and an upper container (20) is configured as a syringe with a plunger (50) and a filtering medium (40) in an outlet at an open bottom of the upper container (20). During filtration, the outlet is dipped into the liquid in the lower container (30). As the plunger (50) is raised, a liquid (10) passes through the filtering medium and gets collected in the top container (20), while a solid substance (10a) settles at a bottom of the lower container (30). Even though this arrangement is effective in minimizing clogging, transferring the collected liquid (10) from the upper container (20) to another container is difficult and therefore needs special arrangements therefor. Further, there is a high chance for the liquid (10) getting retained in the lower container (30).

Numerous modern systems have been developed to separate the components in the liquid. For example, centrifugation is a technique to separate components from a solution by applying a centrifugal force according to their size, shape, density, viscosity of the medium and rotor speed. In this method, two miscible substances can be separated and hydrodynamic properties of macromolecules can be analyzed.

United States Patent No.: U.S. Pat. No. 4,154,690 A discloses a device for use in centrifugal separation of components of a liquid. The device includes a separator element slidable within a cylindrical container containing the liquid. As the container is subjected to centrifugation, a portion of the container in contact with the separator element flexes to allow the liquid to pass through a space between the separator element and the flexed portion and to enable the separator element to slide towards a bottom of the container.

PCT Patent Application No.: PCT/DK2010/050056 discloses a device for extracting a sample from a collection media with an increased yield compared to the centrifugation technique. After centrifugation, a solution is subjected through two or more filtering processes for separating the sample from the collection medium.

There is, nevertheless, a continuing interest in providing improved and alternative devices to those which are presently generally available.

There is therefore a need in the art for a device for filtering a liquid and holding the filtrate in a simple, efficient and cost-effective way. There is also a need for a device for filtering a liquid without a need for any powered actuator for applying a pressure for filtering, while minimizing clogging of a filtering medium.

### SUMMARY

The present disclosure proposes a device and method for filtering a liquid and holding filtrate in a simple, efficient and cost-effective way. The device does reverse-filtration without using any powered actuator for applying a pressure for filtering, while minimizing clogging of a filtering medium.

The device comprises a container, a filter unit and a filtering medium. The container holds the liquid which contains at least one solid substance. The filter unit is axially slidable in the container. The filtering medium is provided at a bottom portion of the filter unit and is non-permeable to the solid substance in the liquid.

According to an embodiment, when the container is being slid into the filter unit the liquid passes through the filtering medium and enters the filter unit. The container is formed with a first fastening part, and the filter unit is formed with a second fastening part matching with the first fastening part. When the container and the filter unit are being fastened to each other, the liquid passes through the filtering medium and gets held in the filter unit.

According to an embodiment, the fastening parts together form a mechanical fastener such as a threaded fastener and snap-fit fastener.

According to an embodiment, the filtering medium is removably attached to a bottom of the filter unit.

According to an embodiment, at least a portion of an inner side surface of the container is configured, such that at least a portion of an outer side surface of the filter unit frictionally, axially slides over the inner side surface of the container to form an air-tight seal with the inner side surface of the container, when the filter unit is slid in the container. Further, the solid substance in the liquid is sandwiched between a bottom surface of the filtering medium and an inner bottom surface of the container, when the container and the filter unit are fastened to each other.

According to an alternate embodiment, the filter unit includes a top portion and a bottom portion, wherein the filtering medium is embedded in a side wall of the bottom portion.

According to a further embodiment, the bottom portion of the filter unit is axially slidably attached to the top portion of the filter unit.

Various objects, features, aspects and advantages of the inventive subject matter will become more apparent from the following detailed description of preferred embodiments, along with the accompanying drawing figures in which like numerals represent like components.

### BRIEF DESCRIPTION OF THE ACCOMPANYING DRAWINGS

In the figures, similar components and/or features may have the same reference numerals. Further, various components of the same type may be distinguished by following the reference numerals with a second numeral that distinguishes among the similar components. If only the first reference numeral is used in the specification, the description is applicable to any one of the similar components having the same first reference numeral irrespective of the second reference numeral.

FIG. 1 illustrates an exploded perspective view of the device, in accordance with a first embodiment of the present invention.

FIG. 2 illustrates an exploded longitudinal sectional view of the device, in accordance with a first embodiment of the present invention.

FIG. 3 illustrates a longitudinal sectional view of the device while in use, in accordance with a first embodiment of the present invention.

FIG. 4 illustrates a longitudinal sectional view of the device while in use, in accordance with a first embodiment of the present invention.

FIG. 5 illustrates a longitudinal sectional view of the device while in use, in accordance with a first embodiment of the present invention.

FIG. 6 illustrates an exploded perspective view of the device, in accordance with a first embodiment of the present invention.

FIGS. 7A and 7B illustrate longitudinal sectional views of two different conventional arrangements for filtering a liquid.

FIG. 8 illustrates a longitudinal sectional view of the device while in use, in accordance with a second embodiment of the present invention.

FIG. 9 illustrates a longitudinal sectional view of the device with a bottom portion of a filter unit in an extended position, in accordance with a third embodiment of the present invention.

FIG. 10 illustrates a longitudinal sectional view of the device with a bottom portion of a filter unit in a collapsed position, in accordance with a third embodiment of the present invention.

FIG. 11 illustrates a longitudinal sectional view of the device with a rod in a top position, in accordance with a fourth embodiment of the present invention.

FIG. 12 illustrates a longitudinal sectional view of the device with the rod in a bottom position, in accordance with a fourth embodiment of the present invention.

### DETAILED DESCRIPTION

In accordance with the present disclosure, there is provided a device for filtering a liquid, which will now be described with reference to the embodiments shown in the accompanying drawings. The embodiments do not limit the scope and ambit of the disclosure. The description relates purely to the embodiments and suggested applications thereof.

The embodiments herein and the various features and advantageous details thereof are explained with reference to the non-limiting embodiment in the following description. Descriptions of well-known components and processes are omitted so as to not unnecessarily obscure the embodiments herein. The examples used herein are intended merely to facilitate an understanding of ways in which the embodiments herein may be practiced and to further enable those of skill in the art to practice the embodiment herein. Accordingly, the description should not be construed as limiting the scope of the embodiment herein.

The description hereinafter, of the specific embodiment will so fully reveal the general nature of the embodiments herein that others can, by applying current knowledge, readily modify or adapt or perform both for various applications such specific embodiment without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Various terms as used herein are defined below. To the extent a term used in a claim is not defined below, it should be given the broadest definition persons in the pertinent art have given that term as reflected in printed publications and issued patents at the time of filing.

### Definitions

Filtering: A process of separating a component from another component or from a mixture of multiple components.

Reverse-filtration: A process of forcing a filtrate to move in a direction other than the direction of gravity.

Solid substance: Any natural or synthetic substance in solid, or powder form.

The present disclosure relates to a device. Those skilled in the art would appreciate that various embodiments of the present disclosure enable. Embodiments herein enable filtering the liquid and holding the filtrate in a simple, efficient and cost-effective way without a need for any powered actuator e.g. pump, for applying a pressure for filtering, while minimizing clogging of a filtering medium.

The present invention does reverse-filtration, wherein the filtrate is made to pass through the filtering medium in a direction other than the direction of gravity while pushing the residue in an opposite direction, and therefore chances of clogging in the filtering medium is minimized without compromising with filtrate quality. Further, pressure required for filtering the liquid is exerted from the fastening action, thus filtering and collecting the filtrate in the filter unit simultaneously, while preventing re-mixing of the filtrate with the residue sandwiched between the container and the filter unit.

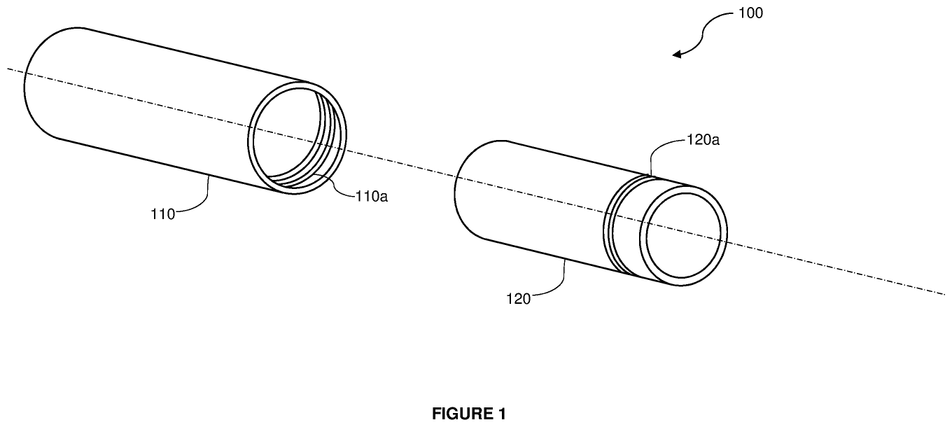

Referring to the accompanying drawings, FIG. 1 illustrates an exploded perspective view of the device, in accordance with a first embodiment of the present invention. The device (100) comprises a container (110) and a filter unit (120) axially slidable in the container (110). The two container (110) and the filter unit (120) are formed of a solid material e.g. plastics, metal, ceramic material, cellulose fibers and the like.

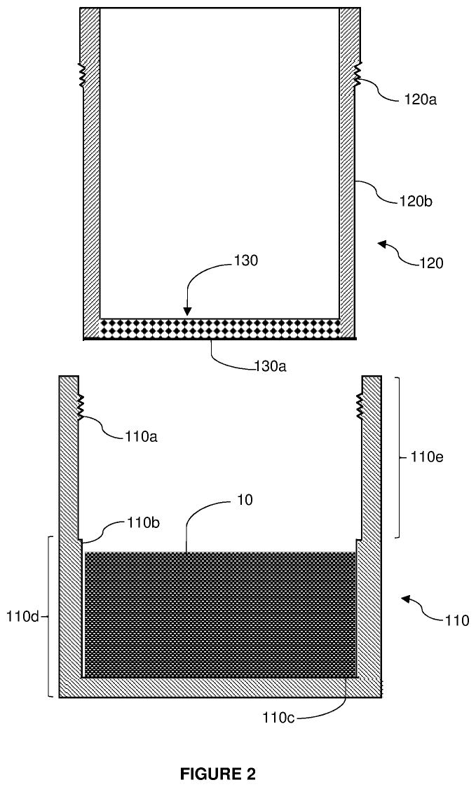

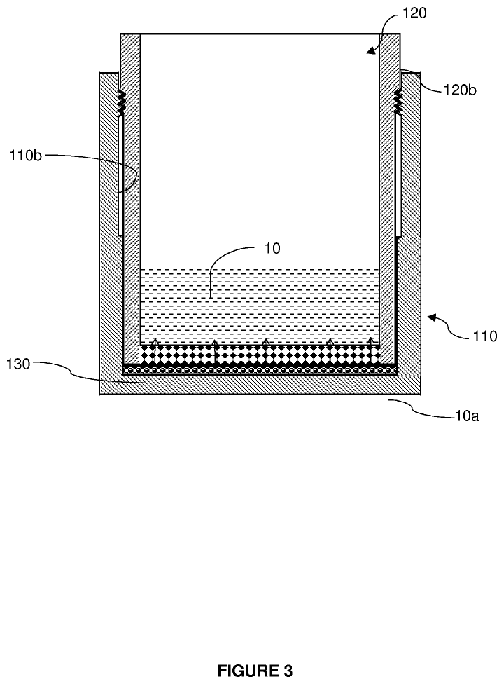

As shown in FIG. 2, the container (110) holds the liquid (10) containing at least one solid substance (10a, shown in FIG. 3). The liquid (10) can be any bodily liquid like blood, urine, milk, tears, mucus, saliva, semen, sweat, pus, etc. In an alternate embodiment, the liquid may be water, beverage, oil, chemical composition, food item, drug and the like. The beverage includes but not limited to coffee, tea, juice, soup, alcoholic beverage, carbonated beverage, etc.

A filtering medium (130) is provided at a bottom of the filter unit (120), wherein the filtering medium (130) is non-permeable to the solid substance (10a, shown in FIG. 3) in the liquid (10). The filtering medium may be a single layer filtering medium such as a sieve, porous membrane, etc., a multi-layer porous filter package such as a filter media disclosed in U.S. Pat. No. 8,679,218 B2, or any other commercially available filter media. In a multi-layer filter package, each layer has at least one pore or hole, and the layers are arranged such that pores or holes of each layer is smaller than those of an immediate bottom layer. The filtering medium (130).

In an exemplary embodiment, the filtering medium (130) is formed as a bottom wall of the filter unit (120). However, in another embodiment, the filtering medium (130) may be removably attached to a bottom wall of the filter unit (120). Further, the filtering medium (130) may be removably attached to a top or bottom of the bottom wall of the filter unit (120).

The container (110) includes a first fastening part (110a), and the filter unit (120) includes a second fastening part (120a) matingly engageable with the first fastening part (110a). In an exemplary embodiment, the fastening parts (110a, 120a) are screw threads, and the container (110) and the filter unit (120) can be fastened to one another by a screwing action. In other embodiments, the fastening parts (110a, 120a) can also be formed as other mechanical fasteners e.g. snap-fit fastener, press-fit fastener, hook and loop fastener and the like.

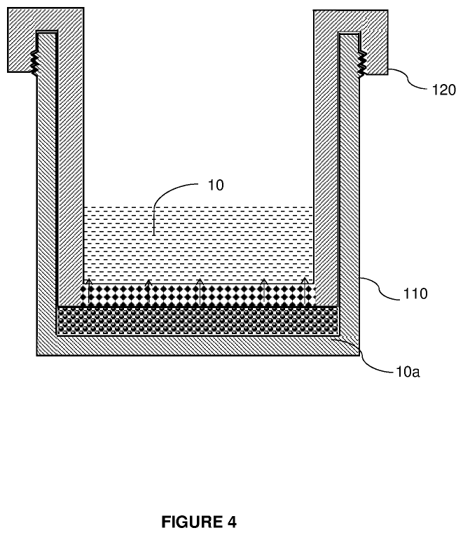

In the first embodiment, the first fastening part (110a) is formed on an inner side surface (110b) of the container (110), and the second fastening part (120a) is formed on an outer side surface (120b) of the filter unit (120). However, both the fastening parts (110a, 120a) may also be formed on outer side surfaces of the container (110) and the filter unit (120), as shown in FIG. 4, with a lip portion of the filter unit (120) inverted, so that the fastening parts (110a, 120a) are in line with one another, when the filter unit (120) is slid into the container (110).

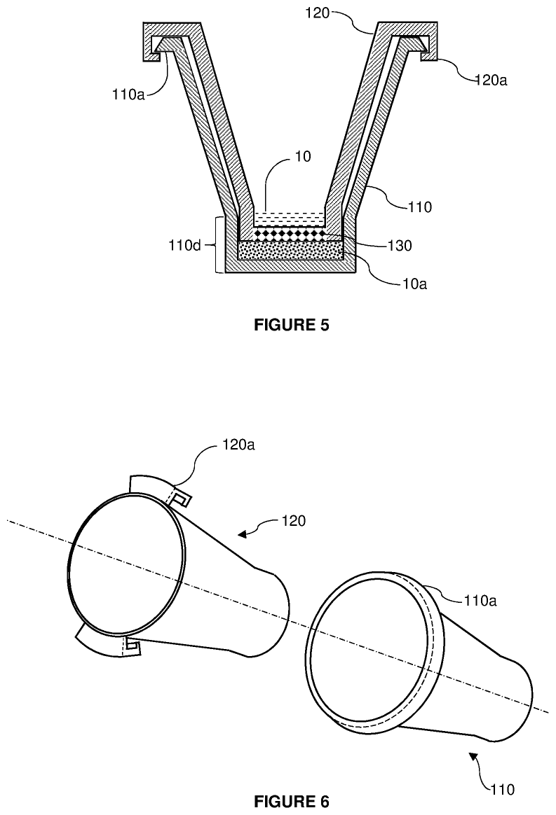

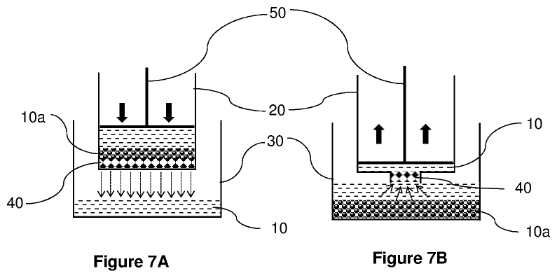

Further, the first fastening part (110a) and second fastening part (120a) may also be formed as a projection around a lip portion of the container (110), and two or more inverted projections around a lip portion of the filter unit (120), respectively, as shown in FIGS. 5 and 6. The fastening parts (110a, 120a) together form a snap-fit fastener, such that the first fastening part (110a) gets locked in the second fastening part (120a) when the filter unit (120) is slid into the container (110).

Moving back to FIG. 3, the device (100) separates the liquid (10) and solid substance (10a), when the container (110) and the filter unit (120) are fastened to each other. As the container (110) and the filter unit (120) are being fastened to each other, the liquid (10) passes through the filtering medium (130) and enters the filter unit (120). Further, the solid substance (10a) is sandwiched between a bottom surface (130a, shown in FIG. 2) of the filtering medium (130) and an inner bottom surface (110c, shown in FIG. 2) of the container (110), when the container (110) and the filter unit (120) are fastened to each other. In a first embodiment, the solid substance (10a) is a powder.

The inner side surface (110b) of the container (110) and the outer side surface (120b) of the filter unit (120) are configured, such that the filter unit (120) is automatically aligned with respect to the container (110), as the filter unit (120) is being slid into the container (110). A cross section of the container (110) and the filter unit (120) can be circular, triangular, polygonal or any other shape that allows a proper alignment between the container (110) and the filter unit (120), when the filter unit (120) to be substantially slid into the container (110).

Further, the configuration of the inner side surface (110b) of the container (110) and the outer side surface (120b) of the filter unit (120) allows a portion of the outer side surface (120b) of the filter unit (120) to be frictionally, axially slid within the inner side surface (110b) of the container (110) to form an air-tight seal between the inner side surface (110b) of the container (110) and the outer side surface (120b) of the filter unit (120). For example, the inner side surface (110b) of the container (110) and/or the outer side surface (120b) of the filter unit (120) is formed with an O-ring to form a sealing contact between the inner side surface (110b) of the container (110) and/or the outer side surface (120b) of the filter unit (120).

Moreover, a negative pressure is formed between the filter unit (120) and the container (110), such that the solid substance (10a) sticking to an underside of the filtering medium (130) is forced to fall into the container (110), when the filter unit (120) is unfastened from the container (110). Thus, a process of cleaning the filtering medium (130) is simplified.

In the first embodiment, the inner side surface (110b) of the container (110) is contoured, such that an upper portion (110e, shown in FIG. 2) of the inner side surface (110b) of the container (110) is wider than a lower portion (110d, shown in FIG. 2) of the inner side surface (110b) of the container (110). An inner diameter of a lower portion (110d, shown in FIG. 2) of the container (110) is at least equal to an outer diameter of the bottom of the filter unit (110), such that the bottom of the filter unit (120) frictionally, axially slides within the inner side surface (110b) of the lower portion (110d, shown in FIG. 2) of the container (110) and forms the air-tight seal with the inner side surface (110b) of the container (110).

By this configuration, a bottom end of the filter unit (120) is substantially free to move in the upper portion (110e, shown in FIG. 2) of the container (110) and starts frictionally, axially sliding in the lower portion (110d, shown in FIG. 2) of the inner side surface (110b) of the container (110). Even though, in the above embodiments, a distance between two ends of a sidewall of the container (110) and the filter unit (120) are mentioned as inner diameter and outer diameter, respectively, it shall be understood that it also refers to a width when non-cylindrical or non-conical container and filter unit are used.

It is to be understood that the figures are only for understanding purpose and are not drawn to the scale of the actual device. In a preferred embodiment, the upper portion (110e, shown in FIG. 2) of the container (110) is conical in shape and the lower portion (110d, shown in FIG. 2) of the container (110) is cylindrical in shape, wherein:
i. a maximum inner diameter of the conical portion is 43.263 millimeters (mm);
ii. a minimum inner diameter of the conical portion is 33 mm;
iii. an inner diameter of the cylindrical portion is 33 mm;
iv. a length of the conical portion is 57.981 mm; and
v. a length of the cylindrical portion is 17.412 mm.

Further, the filter unit (120) is formed in a shape similar to the container (110), except for an additional crown portion, wherein:
a. a maximum outer diameter of the conical portion is 35.127 mm;
b. a minimum outer diameter of the conical portion is 31.124 mm;
c. an outer diameter of the cylindrical portion is 31.124 mm;
d. an outer diameter of the crown portion is 48. 5 mm;
e. a length of the conical portion is 53.91 mm;
f. a length of the cylindrical portion is 16.33 mm; and
g. a length of the crown portion is 19 mm.

Further, the lower portion (110d, shown in FIG. 2) of the inner side surface (110b) of the container (110) and/or the outer side surface (120b) can be coated with a material, not reactive with the liquid (10), to avoid erosion over repeated sliding motions between the container (110) and the filter unit (120).

The complete filtering process carried out by the device (100) is as follows: The liquid (10) to be filtered is collected in the container (110), wherein the liquid (10) contains the solid substance (10a). The liquid (10) is permeable through the filtering medium (130), and the solid substance (10a) in the liquid (10) is non-permeable through the filtering medium (130).

The bottom end of the filter unit (120) is inserted into a top end of the container (110). As the outer diameter of the bottom end of filter unit (120) is at least equal to the inner diameter of the lower portion (110d, shown in FIG. 2) of the container (110), an air-tight seal is formed between the outer side surface (120b) of the filter unit (120) and the inner side surface (110b) of the lower portion (110d) of the container (110), when the bottom end of the filter unit (120) enters a top end of the lower portion (110d, shown in FIG. 2) of the container (110).

The filter unit (120) is further lowered in the container (110) by pushing the filter unit (120) or by the fastening action e.g. screwing action, so that the liquid (10) passes through the filtering medium (130), while the solid substance (10a) is pushed down towards the inner bottom surface (110c, shown in FIG. 2) of the container (110). The pushing or fastening action is continued until no further fastening is possible, so as to hold the liquid (10) in the filter unit (120) and to sandwich the solid substance (10a) between the bottom surface (130a) of the filtering medium (130) and the inner bottom surface (110c, shown in FIG. 2) of the container (110), simultaneously.

As the pressure required for filtering or separating the components (10a, 10b) in the liquid (10) is exerted by means of the fastening action, the present invention eliminates a need for any powered actuator, and therefore reducing complexity and cost of manufacturing and operating the device (10). The present invention does reverse-filtration, wherein the solid (10a) is pushed to a bottom of the container (110a) and the liquid (10) is forced to pass through the filtering medium (130) in the vertically upward direction, as shown in FIG. 3. Thus, avoiding a need for an actuator to force the filtrate, while preventing clogging of the filtering medium. Moreover, the container (110) and the filter unit (120) are fastened to each other for collecting each of the liquid (10) and the solid substance (10a) in the container (110) and the filter unit, (120), respectively, thus separating and collecting the components (10a, 10b) simultaneously without using any actuator e.g. plunger, while preventing re-mixing of the liquid (10) with the solid substances (10a).

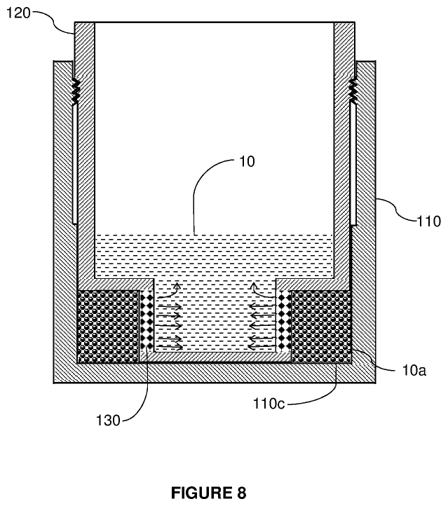

Even though, in the above embodiments, the filtering medium (130) is shown to be forming a bottom of the filter unit (120), it is also possible to provide the filtering medium at a side wall of the filter unit (120), as shown in FIG. 8. In this embodiment, the filtering medium (130) is embedded in the side wall of the filter unit (120) near the bottom of the filter unit (120), so that the bottom of the filter unit (120) is in contact with the inner bottom surface (110c) of the container to minimize a chance of leaving the liquid (10) held in the container (110).

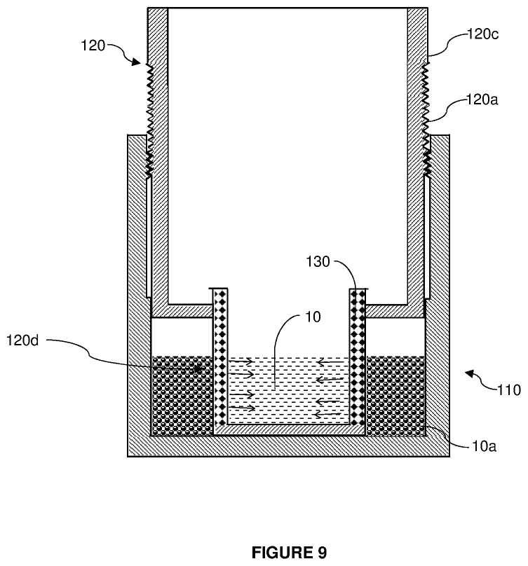

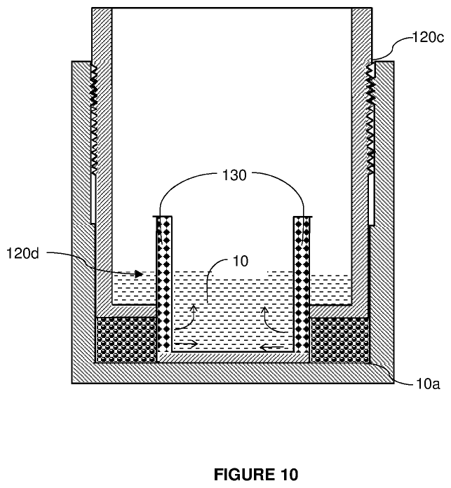

FIG. 9 illustrates a longitudinal sectional view of the device, in accordance with a third embodiment of the present invention. In this embodiment, the filter unit (120) includes a top portion (120c) and a bottom portion (120d) that is axially, slidably attached to a bottom end of the top portion (120c). The bottom portion (120d) is movable between an extended position and a collapsed position (show in FIG. 10). This configuration allows complete separation of the liquid (10) and the solid substance (10a), even when an amount of the solid substance (10a) present in the liquid is unknown.

In this embodiment, a side wall of the bottom portion (120d) is embedded with the filtering medium (130), such that liquid (10) flows into the bottom portion in a direction perpendicular to the direction of gravity. Since a bottom surface of the bottom portion (120d) contacts the inner bottom surface (110c, shown in FIG. 2) of the container (110), there is no chance for the liquid (10) to get trapped between the container (110) and the filter unit (120). Further, the entire bottom portion (120d), including bottom wall and side wall of the bottom portion (120d), can be embedded with the filtering medium (130) to allow a flow of the liquid (10) from bottom as well as sides of the bottom portion (120d). By this way, it is possible to completely separate the components (10a, 10b), while preventing clogging and/or re-mixing of the components (10a, 10b).

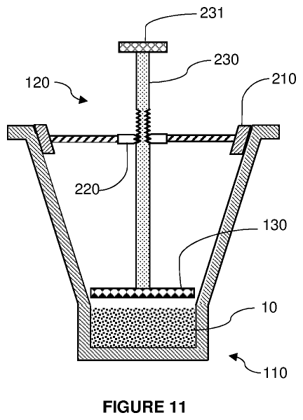

FIG. 11 illustrates a longitudinal sectional view of the device, in accordance with a fourth embodiment of the present invention. In this embodiment, the filter unit (120) comprises an attachment part (210), a guiding part (220) and a rod (230) with a handle (231). The attachment part (210) is formed as a circular ring removably attachable with the container (110). The guiding part (220) is fixed to the attachment part (210) through one or more connectors (211), such that the guiding part (220) forms a center point of the attachment part (210). The guiding part (220) includes a hole (not shown), and the rod (230) passes through the hole.

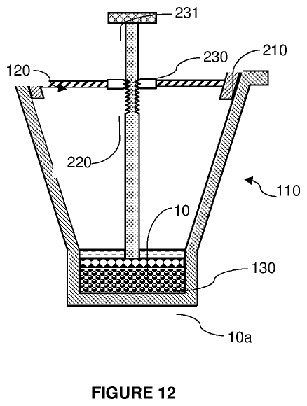

The rod (230) is formed with a threading that mates with threading formed in the hole of the guiding part (220), and the rod (230) is movable between an upper position and a lower position. A top end of the rod (230) is fixed to a handle (231) and a bottom end of the rod (230) is fixed to the filtering medium (130), such that the filtering medium (130) is urged into the container (110), when the rod (230) is moved to the lower position, as shown in FIG. 12.

An edge of the filtering medium (130) is configured, such that the filtering medium (130) frictionally, axially slides over the inner side surface (110b, shown in FIG. 2) of the container (110) and forms an air-tight seal with the inner side surface (110b, shown in FIG. 2) of the container (110), when the filtering medium (130) is urged into the container (110).

In accordance with the exemplary embodiment, the method for filtering the liquid is explained using FIGS. 2 & 3. The method comprises the steps of: collecting the liquid (10) in the container (110), wherein the liquid (10) includes the solid substance (10a), and filtering the liquid (10) using the filtering medium (130) that is non-permeable to the solid substance (10a) in the liquid (10). For filtering, the filtering medium (130) is positioned above a top surface of the liquid (10) and is moved from the top surface towards the inner bottom surface (110c) of the container (110), such that solid substance (10a) is moved downwards and the liquid (10) passes through the filtering medium (130).

While moving the filtering medium (130) a sealing contact is formed between a peripheral edge of the filtering medium (130) and the inner side surface (110b) of the container (110). Further, the filtering medium (130) is moved towards the inner bottom surface (110c) of the container (110) until further movement is stopped by the solid substance (10a) and is locked.

As the solid substance (10a) is pushed to a bottom of the container (110), the liquid (10) is forced to pass through the filtering medium (130) in the vertically upward direction. Thus, preventing clogging of the filtering medium (130), while separating and collecting the liquid (10) and the solid substance (10a) simultaneously and preventing re-mixing of the liquid (10) with the solid substance (10a).

The terminology used herein is for the purpose of describing particular example embodiments only and is not intended to be limiting. As used herein, the singular forms “a”, “an” and “the” may be intended to include the plural forms as well, unless the context clearly indicates otherwise.

The terms “comprises,” “comprising,” “including,” and “having,” are inclusive and therefore specify the presence of stated features, integers, steps, operations, elements, or components, but do not preclude the presence or addition of one or more other features, integers, steps, operations, elements, components, or groups thereof.

The use of the expression “at least” or “at least one” suggests the use of one or more elements, as the use may be in one of the embodiments to achieve one or more of the desired objects or results.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A device for filtering a liquid, comprising a container (110) for holding the liquid (10), wherein the liquid (10) contains at least one solid substance (10a), a filter unit (120) axially slidable in the container (110), and a filtering medium (130) non-permeable to the solid substance (10a) in the liquid (10), characterized in that:
the filtering medium (130) is provided at least near a bottom end of the filter unit (120), such that the liquid (10) passes through the filtering medium (130) and enters the filter unit (120), when the filtering medium (130) is being urged into the container (110).

2. The device of claim 1, wherein the container (110) is formed with a first fastening part (110a), and the filter unit (120) is formed with a second fastening part (120a) matching with the first fastening part (110a).

3. The device of claim 1, wherein the solid substance (10a) in the liquid (10) passes through the filtering medium (130) and enters the filter unit (120), when the container (110) and the filter unit (120) are being fastened to each other.

4. The device of claim 2, wherein the fastening parts (110a, 120a) together form a mechanical fastener.

5. The device of claim 1, wherein the filtering medium (130) is removably attached to the bottom end of the filter unit (120).

6. The device of claim 1, wherein the filtering medium (130) is formed as the bottom end of the filter unit (120).

7. The device of claim 1, wherein at least a portion of an inner side surface (110b) of the container (110) is configured, such that at least a portion of an outer side surface (120b) of the filter unit (120) frictionally, axially slides over the inner side surface (110b) of the container (110) and forms an air-tight seal with the inner side surface (110b) of the container (110), when the filter unit (120) is slid in the container (110).

8. The device of claim 7, wherein an inner diameter of a lower portion (110d) of the container (110) is at least equal to an outer diameter of the bottom end of the filter unit (110), such that the bottom end of the filter unit (120) frictionally, axially slides within the inner side surface (110b) of the lower portion (110d) of the container (110) and forms the air-tight seal with the inner side surface (110b) of the container (110), when the filter unit (120) is urged into the lower portion (110d) of the container (110).

9. The device of claim 2, wherein the solid substance (10a) is sandwiched between a bottom surface (130a) of the filtering medium (130) and an inner bottom surface (110c) of the container (110), when the container (110) and the filter unit (120) are fastened to each other.

10. The device of claim 7, wherein the filter unit (120) includes a top portion (120c) and a bottom portion (120d) that is axially slidably attached to a lower end of the top portion (120c).

11. The device of claim 10, wherein the filtering medium (130) is embedded in a side wall of the bottom portion (120d) of the filter unit (120).

12. The device of claim 10, wherein the bottom portion (120d) of the filter unit (120) is narrower than the top portion (120c) of the filter unit (120).

13. The device of claims 10, wherein an inner diameter of the lower portion (110d) of the container (110) is at least equal to an outer diameter of a bottom end of the top portion (120c) of the filter unit (110), such that the bottom end of the top portion (120c) of the filter unit (120) frictionally, axially slides within the inner side surface (110b) of the lower portion (110d) of the container (110) and forms the air-tight seal with the inner side surface (110b) of the container (110).

14. The device of claim 1, wherein the filtering medium (130) is urged into the container (110) by a sliding motion of the filter unit (120) into the container (110).

15. The device of claim 1, wherein the filter unit (120) comprises:
at least one attachment part for removable attachment with the container (110);
at least one guiding part fixed to the attachment part;
a rod passing through the guiding part and movable between an upper position and a lower position, wherein a top end of the rod is fixed to a handle and a bottom end of the rod is fixed to the filtering medium (130).

16. The device of claim 15, wherein the filtering medium (130) is urged into the container (110), when the rod is moved to the lower position.

17. The device of claim 15, wherein a peripheral edge of the filtering medium (130) is configured, such that the filtering medium (130) frictionally, axially slides over the inner side surface (110b) of the container (110) and forms an air-tight seal with the inner side surface (110b) of the container (110), when the filtering medium (130) is urged into the container (110).

18. A method for filtering a liquid, comprising the steps of: collecting the liquid (10) in a container (110), wherein the liquid (10) includes a solid substance (10a), and filtering the liquid (10) using a filtering medium (130) that is non-permeable to the solid substance (10a) in the liquid (10), characterized in that the step of filtering the liquid (10) includes:
i. positioning the filtering medium (130) above a top surface of the liquid (10) collected in the container (110); and
ii. moving the filtering medium (130) from the top surface towards an inner bottom surface (110c) of the container (110), such that solid substance (10a) is moved downwards and the liquid (10) passes through the filtering medium (130).

19. The method of claim 18, wherein the step of moving the filtering medium (130) includes
forming a sealing contact between a peripheral edge of the filtering medium (130) and an inner side surface (110b) of the container (110).

20. The method of claim 18, wherein the step of moving the filtering medium (130) further includes
moving the filtering medium (130) towards the inner bottom surface (110c) of the container (110) until further movement is stopped by the solid substance (10a); and
locking the filtering medium (130).
